(19) United States
(12) Patent Application Publication
(10) Pub. No.: US 2025/0303902 A1
(43) Pub. Date: Oct. 2, 2025

(54) ELECTRIC VEHICLE HAVING WIND POWERED CHARGING

(71) Applicants: Enow Enow, Douro-Dummer (CA); Anastasiya Rudnick, Douro-Dummer (CA); Esemeliku Enow, Douro-Dummer (CA)

(72) Inventors: Enow Enow, Douro-Dummer (CA); Anastasiya Rudnick, Douro-Dummer (CA); Esemeliku Enow, Douro-Dummer (CA)

(21) Appl. No.: 18/618,176

(22) Filed: Mar. 27, 2024

(51) Int. Cl. B60L 53/52; B62D 35/02

(52) U.S. Cl. CPC B60L 53/52; B62D 35/02

(57) ABSTRACT

An electric vehicle with air driven charging, meticulously designed to facilitate alternating charging and output of batteries during the vehicle's forward motion. Utilizing directed air generated from the vehicle's movement, the vehicle incorporates a central air passage stretching from the vehicle's front to its rear. Within this passage resides at least two air driven generators, primed to generate electrical current. These generators are seamlessly integrated into the vehicle's electrical system, ensuring effective charging and output of the batteries.

### FIELD OF THE INVENTION

The present invention pertains to electric vehicles, specifically an electric vehicle integrating airflow members. These members are designed to direct airflow for operating air-driven electrical generation devices. These devices, in turn, facilitate the charging of the electric vehicle's batteries while it is in forward motion. It's important to note that the description is specific but not exhaustive, encompassing various aspects of electric vehicle technology.

### BACKGROUND

Despite a surge in consumer interest and purchases of electric vehicles (EVs), the latest surveys reveal persisting concerns about their reliability. The reliability issue is particularly pronounced in electric pickups, marking them as the least reliable category among EVs. Across all categories of electric vehicles, the failure rates are notably higher compared to traditional internal combustion engine vehicles. On average, new EVs experience eighty percent more problems than their internal combustion counterparts. This heightened failure rate is partly attributed to the relatively early stage of EVs as mainstream vehicles, leading to inherent challenges. One significant concern revolves around battery life, impacting the driving range achievable on a single charge and posing a key obstacle to widespread EV adoption. As the electric vehicle industry matures, addressing these challenges is imperative for sustained growth and consumer confidence.

The current state of public charging infrastructure for electric vehicles (EVs) remains relatively limited, posing a considerable challenge for installation planning. Charging stations often demand hundreds of kilowatts each, amplifying the complexity of infrastructure development. Despite the introduction of rapid charging stations, a typical EV still requires up to thirty minutes to achieve a full battery charge. Moreover, the energy consumption during rapid charging is significant, akin to the power usage of six households over a 24-hour period. While some EV manufacturers have implemented regenerative braking systems to capture and recharge batteries, there is a lack of substantial advancements in recharging EV batteries during regular usage. These challenges underscore the need for further innovation and infrastructure expansion to enhance the efficiency and convenience of EV charging networks.

Hence, there arises a necessity for the development of an electric vehicle designed with essential components that facilitate the charging of its batteries while the vehicle is in forward motion. This requirement stems from the current limitations where electric vehicles typically rely on stationary charging infrastructure, and the desire for a more dynamic and continuous charging solution during operation. The envisioned electric vehicle configuration should incorporate innovative technologies or systems that enable the replenishment of battery power while the vehicle is in forward motion, addressing the challenges associated with limited charging infrastructure and offering a more seamless and efficient user experience for electric vehicle owners.

### SUMMARY OF THE INVENTION

The primary objective of the current invention is to introduce an electric vehicle specifically designed to charge its batteries while in motion. This innovation centers around a unique configuration, featuring at least one air intake positioned at the front of the vehicle. The integration of this air intake system serves as a crucial element in the invention's design. By incorporating such an arrangement, the electric vehicle aims to harness and utilize airflow during its operation, converting it into a source of energy to facilitate the continuous charging of its batteries. This inventive approach addresses the limitations of conventional stationary charging methods, offering a dynamic solution that enhances the overall efficiency and sustainability of electric vehicles during their on-road performance.

Another key objective of the present invention is to introduce an electric vehicle with integrated air-blown drive charging, a feature designed to enable battery charging while the vehicle is in forward motion. This innovative concept involves fluidly coupling the air intake to a central air passage that spans the entire length of the electric vehicle. This integration is pivotal in the invention's design, as it establishes a continuous and centralized pathway for the airflow. As the vehicle moves forward, the air is efficiently channeled through this extended passage, facilitating the charging process for the batteries. By seamlessly incorporating air-blown drive charging along with the elongated central air passage, the invention strives to optimize energy capture from the vehicle's motion, ensuring a more effective and sustained charging mechanism for enhanced electric vehicle performance.

Another significant aim of the present invention is to furnish an electric vehicle with the capability to charge its batteries while in forward motion. To achieve this, the design incorporates a central air passage extending along the length of the vehicle, within which at least one turbine generator is strategically positioned. These turbine generators are electrically connected to the batteries of the electric vehicle. This integration is pivotal in the invention's architecture, as it involves harnessing the airflow captured through the central air passage to drive the turbine generators. Subsequently, the generators convert this aerodynamic energy into electrical energy, effectively charging the batteries during the vehicle's forward motion. This configuration aligns with the broader goal of enhancing the sustainability and efficiency of electric vehicles by introducing an innovative mechanism for on-the-go battery charging.

A further objective of the present invention is to introduce an electric vehicle with integrated air-blown drive charging for on-the-go battery charging during forward motion. The design incorporates a central air passage that extends along the length of the vehicle, culminating at its end, away from the air intake, with a diffuser. This diffuser plays a critical role in creating a vacuum effect, strategically assisting in energizing the at least one turbine generator. As the airflow travels through the central air passage, reaching the diffuser at its endpoint, the created vacuum enhances the efficiency of the turbine generator by providing an additional force to drive its rotation. This inventive approach ensures optimal energy capture and conversion, contributing to a more effective and sustainable charging process for the electric vehicle's batteries during operation.

Another crucial objective of the present invention is to furnish an electric vehicle designed to charge its batteries while in forward motion. The inventive configuration involves a central air passage extending along the length of the vehicle, featuring a set of plate members within it. These plate members are designed to organize turbulent airflow that enters through the air intake. Their operational role is pivotal in ensuring a more controlled and streamlined airflow as it progresses into the central air passage. By organizing turbulent airflow, the plate members contribute to optimizing the efficiency of the charging process. This inventive feature enhances the overall effectiveness of the air-blown drive charging system, allowing for more reliable and consistent battery charging during the forward motion of the electric vehicle.

An additional objective of the present invention is to introduce an electric vehicle featuring integrated air-blown drive charging for on-the-go battery charging during forward motion. The inventive design incorporates a central air passage that is intentionally shaped to induce a Bernoulli effect on the airflow passing through it. The specific contouring of the central air passage is crucial in creating a dynamic where the air pressure decreases as its velocity increases. This Bernoulli effect enhances the efficiency of the airflow within the passage, contributing to a more effective energy capture mechanism. By leveraging the principles of fluid dynamics, this feature optimizes the charging process, ensuring that the aerodynamic energy from the moving vehicle efficiently drives the turbine generators, ultimately facilitating a more efficient and sustainable charging solution for the electric vehicle's batteries.

Yet another significant objective of the present invention is to introduce an electric vehicle designed to charge its batteries while in motion. This innovation involves the inclusion of additional lateral air flow passage members, which are fluidly coupled with the central air passage. These supplementary passages run laterally and in parallel with the central air passage, converging at the diffuser and enhancing the overall airflow dynamics within the vehicle. The lateral air flow passage members contribute to the efficient capture and utilization of surrounding air during the vehicle's forward motion, complementing the primary central air passage. This inventive configuration ensures a more comprehensive approach to harnessing airflow for energy conversion, further optimizing the air-blown drive charging system. By expanding the pathways for incoming air, this feature enhances the overall effectiveness and sustainability of the charging process for the electric vehicle's batteries. A fundamental objective of the present invention is to enhance the charging and output efficiency of batteries during the forward motion of the vehicle. This is accomplished by incorporating at least two batteries in parallel. While one battery operates in output mode, simultaneously, the other battery or batteries are engaged in charging mode. The mode reverses when the output battery reaches a predetermined threshold, such as 10%. This dynamic and adaptive system ensures a continuous and balanced energy flow, optimizing the utilization of the batteries and promoting sustained performance during the vehicle's operation. Yet another objective of the present invention involves the incorporation of vortex generators (101) within the second portion (17) of the central air passage. These vortex generators are strategically placed to induce a tornado effect, a swirling motion of the air. This tornado effect serves the purpose of further energizing the impalas of the alternators. By introducing this additional element, the inventive design optimizes the efficiency of the air driven charging system, leveraging the enhanced aerodynamic energy generated by the tornado effect to boost the performance of the alternators. This innovative feature contributes to the overall effectiveness and sustainability of the electric vehicle's charging mechanism, aligning with the inventive principles of the present disclosure.

In achieving the aforementioned objectives and those related, the present invention may take the form depicted in the accompanying drawings. It's crucial to note that these drawings serve an illustrative purpose and variations are anticipated as integral to the present invention. The inventive concept allows for flexibility and adaptability, acknowledging that variations and modifications can be made without departing from the scope defined by the claims. This statement emphasizes that the specific embodiment illustrated in the drawings is just one possible manifestation of the invention, and the scope of potential variations is defined by the claims attached to the invention.

### BRIEF DESCRIPTION OF THE DRAWINGS

For a thorough understanding of the present invention, refer to the following Detailed Description and appended claims, considered in conjunction with the accompanying Drawings. This combination provides a comprehensive insight into the features, components, and principles of the invention, offering a detailed exploration that facilitates a deeper understanding of its functionality and scope:

FIG. 1 is a front view of an embodiment of the electric vehicle of the present invention; and

FIG. 2 is a diagrammatic view of the rear portion of the central air passage; and

FIG. 3 is a diagrammatic view of the air flow management system of the present invention; and

FIG. 4 is a rear view of an embodiment of the electric vehicle of the present invention; and

FIG. 5 is a diagrammatic view of the air flow management system of the present invention.

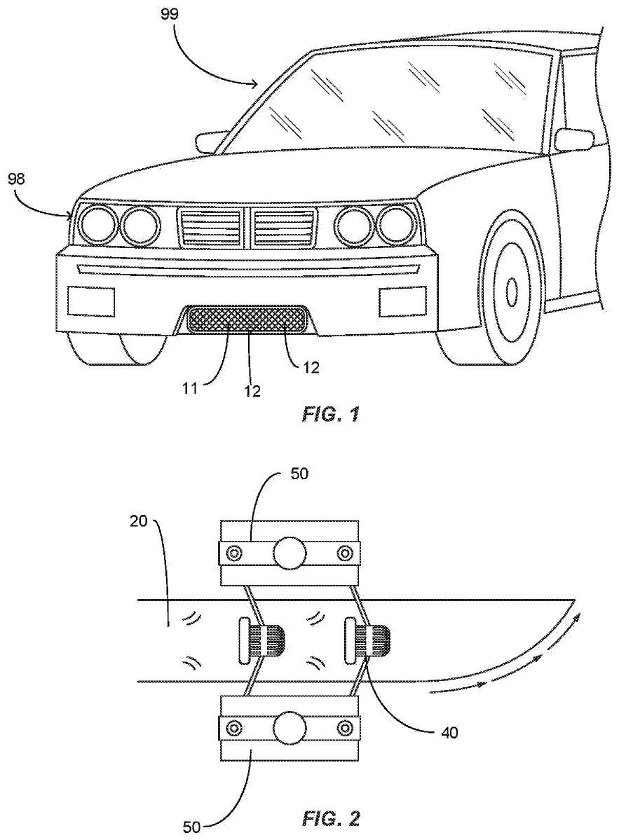

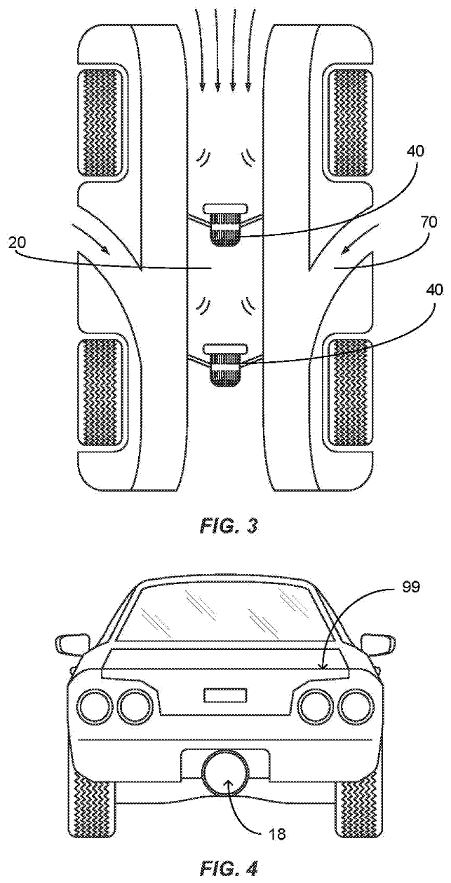

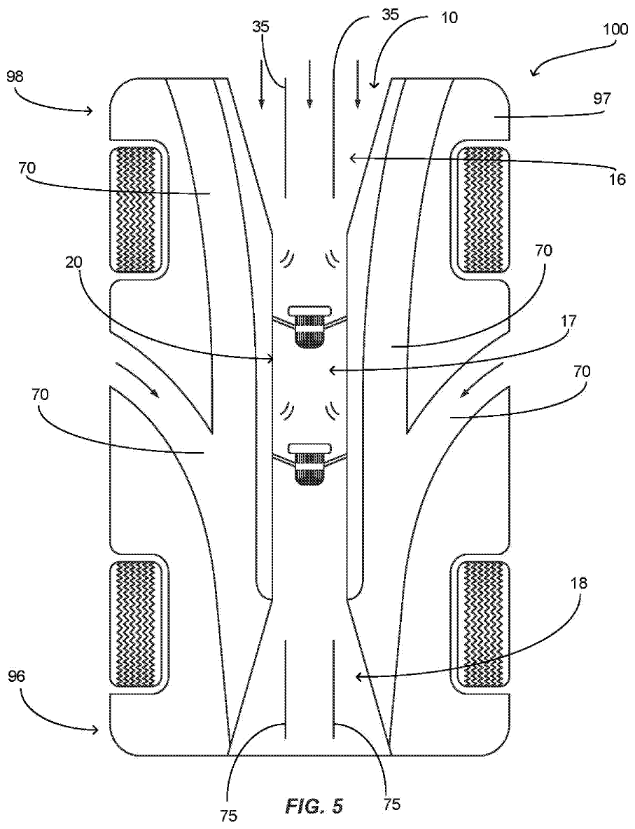

### DETAILED DESCRIPTION

Examining the accompanying drawings, it is essential to note that certain elements depicted therein are not necessarily drawn to scale. Throughout the various views and figures, like elements are consistently referenced with identical reference numerals for clarity and consistency. The drawings portray an electric vehicle with air blown driven charging 100 and are constructed in alignment with the principles of the present invention. These illustrations serve as a visual guide to understanding the specific configurations and features embodied in the electric vehicle, providing valuable insights into the inventive concepts and their application in practice.

An embodiment of the present invention is discussed herein with reference to the figures submitted herewith. It is important for those skilled in the art to recognize that the detailed description provided in connection with these figures is meant for explanatory purposes. Additionally, it is acknowledged within the scope of the present invention that alternative embodiments are plausible. While the detailed description offers specific insights, it is not limiting, and those with expertise in the field will discern numerous alternate and suitable approaches. The implementation choices in the described embodiment serve as examples rather than limitations. Depending on the specific needs of the application, various modifications and embodiments fall within the expansive scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring to the Figures submitted herewith, the electric vehicle with air driven charging 100 is portrayed as an exemplary passenger vehicle 99 within the submitted drawings. It is crucial to note that within the scope of the present invention, the passenger vehicle 99, while illustrated as a standard passenger vehicle in this embodiment, can encompass various types such as trucks or commercial vehicles within the broader scope of the present invention. The passenger vehicle 99 features an air intake 10 positioned at its front end 98. This air intake 10 incorporates a grate 11, configured with multiple apertures 12 to filter the incoming air, preventing the passage of dirt and debris. Importantly, the air intake 10 is functionally connected to the central air passage 20, which is integrated into the lower frame 97 of the vehicle 99. Extending from the front end 98 to the rear end 96, the central air passage 20 forms a critical component facilitating the airflow dynamics for the air driven charging system.

The central air passage 20 is composed of three contiguous portions: a first portion 16, a second portion 17, and a third portion 18. The first portion 16 exhibits a tapered form, with the section near the air intake having a width greater than the width adjacent to the second portion 17. This tapering design induces a Bernoulli effect in the airflow through the central air passage 20. The Bernoulli effect occurs when a moving fluid accelerates as it passes through a constricted section, a well-known phenomenon in fluid dynamics. The second portion 17 is intentionally narrower than the first portion 16 to enhance the acceleration of the air within the central air passage 20. This increased air speed is harnessed to drive the generators 40 more efficiently, as elaborated further herein. While the preferred embodiment involves a tapered section to induce acceleration, it is within the scope of the present invention for the central air passage 20 to have a consistent width throughout its length. Additionally, the central air passage 20 could be situated in alternative locations, not limited to the illustrated lower frame 97. For instance, the central air passage 20 might be embodied as smaller, numerous passages located elsewhere on the vehicle 99, expanding the versatility of the invention.

The central air passage 20 includes first vertical plate members 35 mounted in the first portion 16. The first vertical plate members 35 are mounted to the lower frame 97 utilizing suitable techniques and are perpendicular therewith. The first vertical plate members 35 are mounted within the first portion 16 and function to reduce the turbulence of the airflow entering the first portion 16 wherein the first vertical plate members 35 provide linear direction of the airflow as the airflow flows into the second portion 17. While two first vertical plate members 35 are illustrated herein, it should be understood within the scope of the present invention that the electric vehicle with wind driven charging 100 could employ more than two first vertical plate members 35.

Disposed within the central air passage 20 are generators 40. Generators 40 are conventional wind driven alternator and/or charging devices that include a rotational component that are rotated by the airflow traversing through the central passage 20. The generators 40 are electrically coupled to the batteries 50 and are operable to provide charging thereof. The generators 40 are disposed within the second portion 17 of the preferred embodiment of the present invention as the airflow through the second portion 17 is at a faster rate than other portions of the central air passage 20. It is contemplated within the scope of the present invention that the generators 40 could be provided in alternate styles and sizes and provide the functionality as described herein. While two generators 40 are illustrated herein, it should be understood within the scope of the present invention that the electric vehicle with wind driven charging 100 could employ as few as one generator 40 or more than two generators 40 to provide electrical current to the batteries 50 so as to provide charging thereof. The batteries 50 are conventional lithium ion batteries and it should be understood within the scope of the present invention that the electric vehicle with wind driven charging 100 could have alternate quantities and sizes of batteries 50.

The floor of the car 97 is equipped with integral directional members 70 strategically formed within. These directional members 70, crafted through appropriate techniques, serve to guide additional airflow around and into the central air passage 20 at the diffuser. Within the scope of the present invention, it is considered that the central air passage 20 may take the form of a tunnel, open and in fluid communication with the air underneath the vehicle 99, as formed in the floor of the car 97. Alternatively, the central air passage 20 could be a fully enclosed passage extending through the vehicle 99 or a portion thereof. The third portion 18 of the central air passage 20 located at the diffuser exhibits a width greater than that of the second portion 17, creating a venturi effect. This third portion 18 is tapered, widening as it extends away from the second portion 17, and open at the floor, generating a pressure differential that aids in accelerating the airflow, enhancing the venturi effect. Additionally, the third portion 18 incorporates a second set of vertical plate members 75, mirroring the construction and function of the first vertical plate members 35. Within the second portion 17, additional vertical plate members are strategically positioned at angles to generate vortexes, thereby intensifying the tornado effect. These plate members play a pivotal role in organizing the airflow dynamics within the central air passage 20, contributing to the overall efficiency of the air driven charging system. Another aspect of the present invention is to establish a system of alternating output and charging between batteries while the vehicle is in forward motion. This involves a dynamic operation where one battery is in output mode, supplying power, while the other battery is simultaneously in charging mode, replenishing its energy reserves. This alternating pattern ensures a continuous and balanced power distribution. The transition between output and charging modes occurs based on predefined criteria, such as when the output level drops below a specified threshold, for example, a 10% reserve. This intelligent switching mechanism guarantees efficient utilization of the battery resources, optimizing the overall performance and sustainability of the electric vehicle during forward motion. Yet another objective of the present invention involves the incorporation of vortex generators 101 within the second portion 17 of the central air passage. These vortex generators are strategically placed to induce a tornado effect, a swirling motion of the air. This tornado effect serves the purpose of further energizing the impalas of the alternators. By introducing this additional element, the inventive design optimizes the efficiency of the air driven charging system, leveraging the enhanced aerodynamic energy generated by the tornado effect to boost the performance of the alternators. This innovative feature contributes to the overall effectiveness and sustainability of the electric vehicle's charging mechanism, aligning with the inventive principles of the present disclosure. The diffuser 18, designed to create a venturi effect, plays a crucial role in extracting air from the second portion 17 of the central air passage, aligning with the objectives of the present invention. This venturi effect not only accelerates the air in the second portion 17 but also contributes to reducing air resistance in the first portion 16 as the vehicle moves against the resistance of the air during motion. In conjunction with the diffuser, the directional members 70 serve to amplify the airflow around the central air passage 20, directing it toward the opening in the diffuser 18. The primary goal of this configuration is to enhance the venturi effect by energizing and optimizing the efficiency of the diffuser. By channeling and intensifying the airflow through strategic design elements, the invention aims to further improve the overall performance and effectiveness of the air driven charging system, especially during the vehicle's forward motion.

Although the central air passage 20 has been presented with specific design elements, encompassing a first portion 16, second portion 17, and third portion 18, it is crucial to recognize that within the scope of the present invention, alternative configurations are conceivable. The central air passage 20 may adopt a consistent width from its initial to final ends, deviating from the illustrated tapered design. Furthermore, the central air passage 20 could be situated in alternative locations on the vehicle 99, providing flexibility in the implementation of the air driven charging system. This adaptability allows for variations in the design and placement of the central air passage, catering to diverse vehicle architectures and requirements.

The electric vehicle with air driven charging, as per the present invention, is meticulously designed to facilitate alternating charging and output of batteries during the vehicle's forward motion. Utilizing directed air generated from the vehicle's movement, the innovation incorporates a central air passage stretching from the vehicle's front to its rear. Within this passage resides at least two air driven generators, primed to generate electrical current. These generators are seamlessly integrated into the vehicle's electrical system, ensuring effective charging and output of the batteries. The central air passage features three distinct portions, with the middle section having a width narrower than those flanking it. This deliberate design enhances the venturi effect, optimizing the air dynamics for improved efficiency. To further augment this effect, the central air passage employs angled plate members, ingeniously generating a tornado-like airflow. This comprehensive approach underscores the invention's commitment to maximizing the benefits of directed air for efficient battery charging and output during the vehicle's forward motion. The placement of the central air passage within the lower frame and above the vehicle floor is a key design consideration, emphasizing integration without compromising the vehicle's structure. The floor of the vehicle, featuring additional air flow directional members, adopts a deeper, medially positioned configuration with bilateral and raked anterior-posterior elements. This design resembles a gutter rather than a conventional tube, promoting airflow efficiency. The floor directional members 70 incorporate an air intake 102 positioned in front of the vehicle and aligned with the central air intake 10. This strategic arrangement enhances the overall air intake capability. The main air intake grid is designed with flexibility, allowing for variable sizes or a larger grid to capture a more substantial volume of air. This adaptability ensures optimal utilization of available airflow, aligning with the vehicle's innovative approach to air-driven charging.

In the detailed description provided earlier, the accompanying drawings have been referenced, depicting specific embodiments in which the invention may be implemented. These embodiments, along with potential variations, have been described with sufficient detail to enable those skilled in the art to practice the invention. However, it is important to acknowledge that other suitable embodiments may exist, and logical changes can be made without departing from the spirit or scope of the invention. The description may have omitted certain details known to those skilled in the art. Thus, the preceding detailed description is not intended to be restricted to the specific forms outlined herein. On the contrary, it is meant to encompass alternatives, modifications, and equivalents that fall within the reasonable scope of the appended claims.

What is claimed is:

1. An electric vehicle configured to provide charging of batteries during forward motion of the electric vehicle wherein the electric vehicle comprises:
a vehicle frame, said vehicle frame having a body, said body forming a passenger compartment operable to receive and transport passengers;
at least one battery, said at least one battery configured to provide power for operation of the electric vehicle;
a central air passage, said central air passage having a first end and a second end, said central air passage extending through at least a portion of the electric vehicle, said central air passage having an opening at said first end and said second end, said central air passage configured to have air flow therethrough;
at least one generator, said at least one generator being disposed in said central air passage, said at least one generator configured to produce an electrical current, said at least one generator being operated by air flowing through said central passage, said at least one generator operably coupled to said at least one battery, said at least one generator configured to provide charging of said at least one battery.

2. The electric vehicle configured to provide charging of batteries during forward motion of the electric vehicle as recited in claim 1, wherein said central air passage includes a first portion, a second portion and a third portion, said first portion, said second portion and said third portion being contiguously formed.

3. The electric vehicle configured to provide charging of batteries during forward motion of the electric vehicle as recited in claim 2, wherein said first portion of said central air passage is proximate a front end of the electric vehicle.

4. The electric vehicle configured to provide charging of batteries during forward motion of the electric vehicle as recited in claim 3, wherein said second portion is intermediate said first portion and said third portion.

5. The electric vehicle configured to provide charging of batteries during forward motion of the electric vehicle as recited in claim 4, wherein said second portion has a width that is less than a width of the first portion and third portion.

6. The electric vehicle configured to provide charging of batteries during forward motion of the electric vehicle as recited in claim 5, wherein said first portion includes an opening having an intake grate formed thereacross.

7. The electric vehicle configured to provide charging of batteries during forward motion of the electric vehicle as recited in claim 6, wherein said central air passage further includes first vertical plate members, said first vertical plate members being disposed in said first portion of said central air passage, said first vertical plate members operable to reduce turbulence in airflow passing through the first portion.

8. The electric vehicle configured to provide charging of batteries during forward motion of the electric vehicle as recited in claim 7, wherein said at least one generator is mounted within said second portion of said central air passage.

9. The electric vehicle configured to provide charging of batteries during forward motion of the electric vehicle as recited in claim 8, wherein the frame further includes directional members, said directional members operable to direct airflow into said central air passage.

10. The electric vehicle configured to provide charging of batteries during forward motion of the electric vehicle as recited in claim 9, and further including a second set of vertical plate members, said second set of vertical plate members being mounted in said third portion of said central air passage, said second set of vertical plate members assisting in creating a pressure differential between said second portion and said third portion of said central air passage so as to accelerate airflow through said second portion.
